(19) United States
(12) Patent Application Publication
(10) Pub. No.: US 2025/0068107 A1
(43) Pub. Date: Feb. 27, 2025

(54) IMAGE FORMING SYSTEM AND STORAGE MEDIUM

(71) Applicant: Konica Minolta, Inc., Tokyo (JP)

(72) Inventor: Taku SATO, Tokyo (JP)

(21) Appl. No.: 18/811,626

(22) Filed: Aug. 21, 2024

(30) Foreign Application Priority Data
Aug. 24, 2023 (JP) 2023-136484

(51) Int. Cl. G03G 15/00; H04N 1/00

(52) U.S. Cl. CPC G03G 15/5012; G03G 15/6517; H04N 1/0057; H04N 1/00671

(57) ABSTRACT

Provided is an image forming system that includes a conveyance section, an image forming section, an image reading section, a winding section, and a hardware processor. The hardware processor controls, when a plurality of print jobs is printed on one continuous recording medium held in the image forming system, conveyance by the conveyance section such that a stop position of a last image of a preceding print job on the continuous recording medium is to be a first stop position between the image reading section and the winding section, and controls, when printed on the one continuous recording medium is not a plurality of print jobs, the conveyance by the conveyance section such that the stop position of the last image on the continuous recording medium is to be a second stop position that is closer to the winding section than the first stop position.

### CROSS-REFERENCE TO RELATED APPLICATIONS

The entire disclosure of Japanese Patent Application No. 2023-136484, filed on Aug. 24, 2023, including description, claims, drawings and abstract is incorporated herein by reference.

### BACKGROUND OF THE INVENTION

### Technical Field

The present invention relates to an image forming system and a storage medium.

### Description of the Related Art

Conventionally, image forming systems including a sheet feed device, an image forming device, and a winding device have been known. A sheet feed device is a device that feeds continuous sheets to an image forming device. An image forming device is a device that forms images on continuous sheets fed from a sheet feed device. A winding device is a device that winds continuous sheets ejected from an image forming device.

In such an image forming system, after the image formation processing of a print job is completed, it is desired to control the position where the last image formed on the continuous sheet is stopped, depending on the situation.

For example, when a print job is finished and the continuous sheet wound by the winding device is carried out to a subsequent process, it is desirable to set the stop position of the last image to the winding position in order to easily carry out the continuous sheet. On the other hand, in a case where images of a plurality of print jobs are continuously formed on the same continuous sheet, it is desired that the stop position of the last image is set to a position right after passing through the image forming section in order to reduce waste sheet between print jobs.

In this regard, the following image forming system is described in Japanese Unexamined Patent Publication No. 2017-049429. Specifically, in a waste paper suppression mode, the image forming system stops the last image formed on the continuous sheet immediately after the continuous sheet has passed through the fixing section. On the other hand, when not in the waste paper suppression mode, the image forming system stops the last image formed on the continuous sheet in the winding device.

However, the following problem occurs in the image forming system including the image reading device between the image forming device and the winding device. Specifically, if the last image formed on the continuous sheet is stopped right after passing through the fixing section in the waste paper suppression mode of Japanese Unexamined Patent Publication No. 2017-049429, the image reading device cannot read the last image on the continuous sheet. In this case, since the last image on the continuous sheet needs to be stopped at the winding device in order to read the last image, the waste paper suppression mode does not work, and waste sheet cannot be reduced.

### SUMMARY OF THE INVENTION

An object of the present invention is to provide an image forming system and a storage medium capable of reducing waste sheet even when the image forming system includes an image reading device.

To achieve at least one of the abovementioned objects, according to one aspect of the present invention, provided is an image forming system that forms an image on a continuous recording medium, the image forming system including:
a conveyance section that conveys the continuous recording medium;
an image forming section that forms an image on the continuous recording medium;
an image reading section that reads the image on the continuous recording medium;
a winding section that winds up the continuous recording medium; and
a hardware processor that controls, when a plurality of print jobs is printed on one continuous recording medium held in the image forming system, conveyance by the conveyance section such that a stop position of a last image of a preceding print job on the continuous recording medium is to be a first stop position between the image reading section and the winding section,
and that controls, when printed on the one continuous recording medium is not a plurality of print jobs, the conveyance by the conveyance section such that the stop position of the last image on the continuous recording medium is to be a second stop position that is closer to the winding section than the first stop position.

According to another aspect of the present invention, provided is an image forming system that forms an image on a continuous recording medium, the image forming system including:
a conveyance section that conveys the continuous recording medium;
an image forming section that forms an image on the continuous recording medium;
an image reading section that reads an image on the continuous recording medium;
a winding section that winds up the continuous recording medium; and
a hardware processor that controls, when image reading of an image formed on the continuous recording medium is performed by the image reading section, conveyance by the conveyance section such that a stop position of a last image on the continuous recording medium is a first stop position between the image reading section and the winding section
and that controls, when the image reading of the image formed on the continuous recording medium is not performed by the image reading section, the conveyance by the conveyance section such that the stop position of the last image on the continuous recording medium is a third stop position between the image forming section and the image reading section.

According to another aspect of the present invention, provided is a non-transitory computer-readable storage medium storing a program for a computer of an image forming system,
wherein the image forming system includes:
   a conveyance section that conveys the continuous recording medium;
   an image forming section that forms an image on the continuous recording medium;
   an image reading section that reads the image on the continuous recording medium; and
   a winding section that winds up the continuous recording medium,
wherein the program causes the computer of the image forming system to:
   control, when a plurality of print jobs is printed on one continuous recording medium held in the image forming system, conveyance by the conveyance section such that a stop position of a last image of a preceding print job on the continuous recording medium is to be a first stop position between the image reading section and the winding section; and
   control, when printed on the one continuous recording medium is not a plurality of print jobs, the conveyance by the conveyance section such that the stop position of the last image on the continuous recording medium is to be a second stop position that is closer to the winding section than the first stop position.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 shows an example of a schematic configuration of an image forming system according to the present invention;

FIG. 2 is a functional block diagram illustrating a control configuration of the image forming system according to the present invention;

FIG. 3 is a flowchart of stop position control processing;

FIG. 4 shows an example of a correction patch formed on a recording medium by an adjustment print job;

FIG. 5 shows an example of a job image and a correction patch formed on a recording medium; and

FIG. 6 is a flowchart of stop position control processing of a modification example.

### DETAILED DESCRIPTION OF EMBODIMENTS

Hereinafter, embodiments of the present invention will be described with reference to the drawings. However, the scope of the invention is not limited to the illustrated examples.

A configuration of an image forming system according to the present embodiment is described below.

### 1. Configuration of Image Forming System

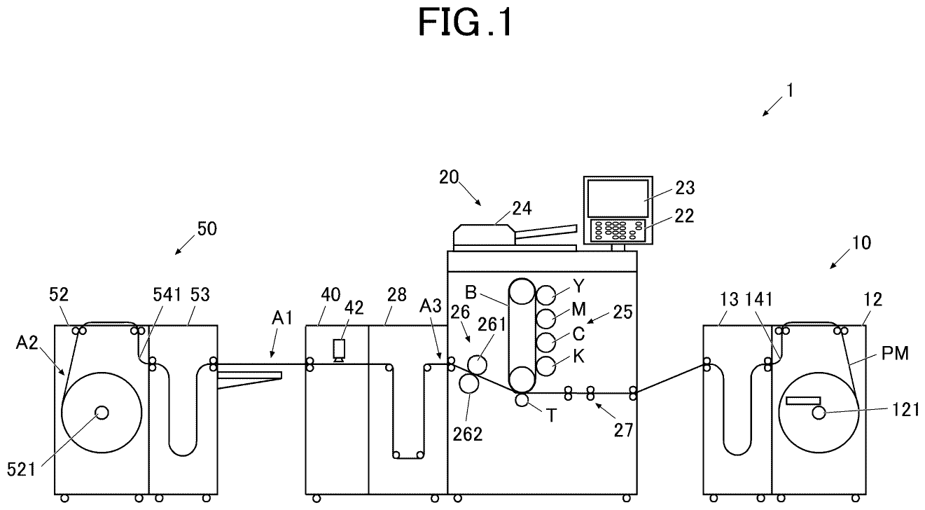

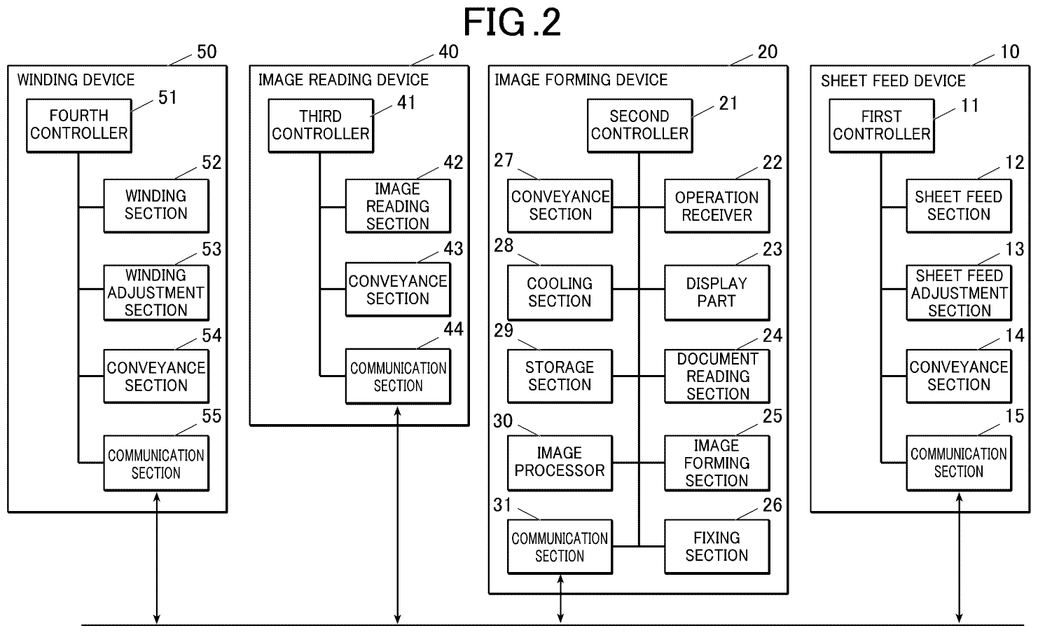

FIG. 1 shows an example of a schematic configuration of the image forming system 1. FIG. 2 is a functional block diagram illustrating a control configuration of the image forming system 1.

The image forming system 1 is a system that uses a recording medium PM (continuous recording medium), such as continuous paper sheet or continuous film, and forms images on the recording medium PM.

As shown in FIG. 1, the image forming system 1 includes a sheet feed device 10, an image forming device 20, an image reading device 40, and a winding device 50 from the upstream side along a conveyance direction of the recording medium PM.

### (1-1. Configuration of Sheet Feed Device)

The sheet feed device 10 feeds the recording medium PM to the image forming device 20.

The sheet feed device 10 includes a first controller 11, a sheet feed section 12, a sheet feed adjustment section 13, a conveyance section 14, and a communication section 15.

The first controller 11 includes a central processing unit (CPU), a read only memory (ROM), and a random access memory (RAM).

The CPU of the first controller 11 reads a program stored in the ROM, deploys the program in the RAM, and integrally controls each section of the sheet feeding device 10 according to the deployed program.

In the housing of the sheet feed section 12, for example, as illustrated in FIG. 1, the sheet feed section 12 holds the recording medium PM in a roll form wound around the support shaft 121 such that the recording medium PM can be rolled around a support shaft 121. The sheet feed section 12 conveys the recording medium PM wound around the support shaft 121 to the sheet feed adjustment section 13 at a constant speed via a plurality of rollers. The plurality of rollers is, for example, a delivery roller, a sheet feed roller, and the like.

Although only one recording medium PM is shown in FIG. 1, the sheet feed section 12 may hold a plurality of continuous recording media.

The sheet feed adjustment section 13 is located on the downstream side of the sheet feed section 12 and on the upstream side of the image forming device 20 in the conveyance direction of the recording medium PM.

The sheet feed adjustment section 13 conveys the recording medium PM conveyed from the sheet feed section 12 to the image forming device 20. The sheet feed adjustment section 13 absorbs a speed difference between a conveyance speed of the recording medium PM in the sheet feed section 12 and a conveyance speed of the recording medium PM in the image forming device 20. Specifically, the sheet feed adjustment section 13 holds the recording medium PM in a slack state as illustrated in FIG. 1, and adjusts the feed of the recording medium PM to the image forming device 20.

The conveyance section 14 includes a conveyance path 141 that connects the sheet feed section 12 to the image forming device 20, and conveys the sheet.

The communication section 15 includes a communication control card such as a local area network (LAN) card. The communication section 15 exchanges various kinds of data with an external device such as the image forming device 20 connected to a communication network such as a LAN or a wide area network (WAN).

### (1-2. Configuration of Image Forming Device)

The image forming device 20 forms an image on the recording medium PM. The image forming device 20 is located on the downstream side of the sheet feed adjustment section 13 and on the upstream side of the image reading device 40 in the conveyance direction of the recording medium PM.

As illustrated in FIG. 2, the image forming device 20 includes a second controller 21 (hardware processor), an operation receiver 22, a display part 23, a document reading section 24, an image forming section 25, a fixing section 26, a conveyance section 27, a cooling section 28, a storage section 29, an image processing section 30, and a communication section 31.

The second controller 21 includes, for example, a CPU and a RAM.

The CPU of the second controller 21 reads a program stored in the storage section 29, deploys the program in the RAM, and integrally controls the entire image forming system 1 including each section of the image forming device 20 according to the deployed program.

For example, the second controller 21 controls the communication section 31 so as to receive a print job, image data, and the like transmitted from an external device. The second controller 21 controls the image forming section 25 so as to form an image on the recording medium PM based on the received print job, image data, and the like.

The operation receiver 22 includes a touch screen formed so as to cover a display screen of the display part 23, and various operation buttons such as numeric buttons and a start button.

The operation receiver 22 outputs, to the second controller 21, operation signals based on the user operation.

The display part 23 includes a liquid crystal display (LCD) or the like.

The display part 23 displays various screens according to command of display signals input from the second controller 21.

The document reading section 24 includes an auto document feeder (ADF) and a reading section such as a charge coupled device (CCD).

The document reading section 24 reads an image of a document based on setting information received by the operation receiver 22, and generates image data for the read image. Specifically, the document reading section 24 conveys a document placed on a document tray of the ADF to an exposure glass, a reading position. Alternatively, the user places the document on the platen glass. Next, the document reading section 24 reads an image on one side or both sides of the document by the reading section and generates image data thereof.

The image forming section 25 forms a toner image by an electrophotographic method and transfers the toner image onto the recording medium PM.

As shown in FIG. 1, the image forming section 25 includes photosensitive drums (Y, M, C, and K) as image bearing members, an intermediate transfer belt B, a transfer roller T, and the like.

The intermediate transfer belt B is an endless belt. The image forming section 25 winds the intermediate transfer belt B around a plurality of rollers and thus supports the intermediate transfer belt B so as to allow it to run.

The transfer roller T is pressed by the intermediate transfer belt B and is driven to rotate.

The image forming section 25 uniformly charges the photosensitive drums (Y, M, C, and K). Thereafter, the image forming section 25 scans and exposes the photosensitive drum with a laser beam on the basis of image data for each color to form an electrostatic latent image on the photosensitive drum. Next, the image forming section 25 causes the developing device to attach toner of each color to the electrostatic latent image on the photosensitive drum to form a toner image of each color, and sequentially transfers the toner image onto the intermediate transfer belt B (primary transfer). As a result, the image forming section 25 forms a toner image (color image) in which layers of the respective colors (Y, M, C, and K) are superimposed onto the intermediate transfer belt B. Next, the image forming section 25 applies a bias (voltage) having a polarity opposite to that of the toner to the transfer roller T. The image forming section 25 thereby transfers the toner image formed on the intermediate transfer belt B onto the recording medium PM (secondary transfer).

The fixing section 26 fixes the toner image secondarily transferred onto the recording medium PM.

As illustrated in FIG. 1, the fixing section 26 includes a pair of rollers, consisting of a heating roller 261 and a pressure roller 262, to nip the recording medium PM.

The fixing section 26 heats the heating roller 261 to a predetermined temperature by a heater as a heat source.

The fixing section 26 biases the pressure roller 262 toward the heating roller 261 by an elastic member (not shown in the drawings).

The fixing section 26 applies heat and pressure to the recording medium PM to which the toner image has been transferred by passing the recording medium PM through a nip portion between the heating roller 261 and the pressure roller 262, and melts and fixes the toner image.

The conveyance section 27 is a conveyance mechanism for the recording medium PM inside the image forming device 20. The conveyance section 27 conveys, with use of, for example, a plurality of rollers, the recording medium PM conveyed from the sheet feed adjustment section 13 to the image forming section 25, the fixing section 26, and the cooling section 28 in this order, and ejects the recording medium PM.

The cooling section 28 is located on the downstream side of the fixing section 26 and on the upstream side of the image reading device 40 in the conveyance direction of the recording medium PM.

The cooling section 28 includes a fan or the like, and cools the recording medium PM heated by the fixing section 26. Accordingly, it is possible to prevent a change in reading characteristics in the image reading device 40 due to expansion of the recording medium PM or a change in color of toner by heat, or the like.

The storage section 29 includes, for example, a hard disk drive (HDD) and a semiconductor nonvolatile memory.

The storage section 29 stores various programs such as a system program and a processing program to be executed by the second controller 21, and data required for execution of these programs.

The image processing section 30 performs necessary image processing on the image data stored in the storage section 29, the image data obtained by the document reading section 24 reading an image from a document, the image data input from an external device, and the like. Next, the image processing section 30 transmits the image data after the image processing to the image forming section 25.

The image processing includes tone processing, halftone processing, color conversion processing, and the like. The tone processing is converting a tone value of each pixel of the image data into a tone value corrected such that the density level properties of the image formed on the sheet matches the target density level properties. The halftone processing is error diffusion processing, screen processing using an ordered dither method, or the like. The color conversion processing is converting each gradation value of RGB into each gradation value of CMYK.

The communication section 31 includes a communication control card such as a LAN card. The communication section 31 transmits and receives various kinds of data to and from external devices such as the sheet feed device 10, the image reading device 40, and the winding device 50 connected to the communication network such as a LAN or a WAN.

The image forming device 20 may be a multi-function peripheral (MFP) having a copy function, a scan function, a facsimile function, and the like in addition to an image forming function.

### (1-3. Configuration of Image Reading Device)

The image reading device 40 is located on the downstream side of the image forming device 20 in the sheet conveyance direction and on the upstream side of the winding device 50 in the sheet conveyance direction.

The image reading device 40 reads the sheet conveyed from the image forming device 20 and outputs data of the obtained read image to the second controller 21 of the image forming device 20.

The image reading device 40 includes a third controller 41, an image reading section 42, a conveyance section 43, and a communication section 44.

The third controller 41 includes a CPU, a ROM, a RAM, and the like.

The CPU of the third controller 41 reads a program stored in the ROM, deploys the program in the RAM, and integrally controls each section of the image reading device 40 according to the developed program.

For example, the third controller 41 causes the image reading section 42 to read a sheet conveyed from the image forming device 20, and outputs data of the obtained read image to the second controller 21. Next, the third controller 41 conveys the read sheet to the winding device 50 by the conveyance section 43.

The image reading section 42 reads a sheet surface on which an image is formed by the image forming device 20, and generates read image data in a bitmap format having pixel values of respective colors of R, G, and B.

The image reading section 42 is, for example, a line sensor in which sensors such as charge coupled devices (CCDs) are one dimensionally arranged, an area sensor in which sensors are two dimensionally arranged, or the like.

The conveyance section 43 includes a plurality of roller pairs and conveys a sheet conveyed from the image forming device 20 to the image reading section 42. Next, the conveyance section 43 conveys the sheet read by the image reading section 42 to the winding device 50.

The communication section 44 includes a communication control card such as a LAN card. The communication section 44 transmits and receives various kinds of data to and from external devices such as the image forming device 20 connected to a communication network such as a LAN or a WAN.

### (1-4. Configuration of Winding Device)

The winding device 50 is located on the downstream side of the image reading device 40 in the conveyance direction of the recording medium PM.

The winding device 50 includes a fourth controller 51, a winding section 52, a winding adjustment section 53, a conveyance section 54, and a communication section 55.

The fourth controller 51 includes a CPU, a ROM, a RAM, and the like.

The CPU of the fourth controller 51 reads a program stored in the ROM, deploys the program in the RAM, and integrally controls each section of the winding device 50 in accordance with the deployed program.

The winding adjustment section 53 is located on the downstream side of the image reading device 40 and on the upstream side of the winding section 52 in the conveyance direction of the recording medium PM.

The winding adjustment section 53 delivers the recording medium PM conveyed from the image reading device 40 to the winding section 52. The winding adjustment section 53 absorbs a speed difference between a conveyance speed of the recording medium PM in the image reading device 40 and a conveyance speed of the recording medium PM in the winding section 52. Specifically, the winding adjustment section 53 holds the recording medium PM in a sack state as illustrated in FIG. 1, and adjusts the ejection of the recording medium PM from the image reading device 40.

In the housing of the winding section 52, for example, as illustrated in FIG. 1, the winding section 52 winds the recording medium PM around a support shaft 521 to hold the recording medium PM in a roll state. The winding section 52 winds the recording medium PM conveyed from the winding adjustment section 53 around the support shaft 521 at a constant speed via the plurality of rollers. The plurality of rollers is, for example, a delivery roller and a sheet ejection roller.

The conveyance section 54 includes a conveyance path 541 that connects the image reading device 40 to the winding section 52, and conveys the sheet.

The communication section 55 includes a communication control card such as a LAN card. The communication section 55 transmits and receives various kinds of data to and from an external device such as the image forming device 20 connected to the communication network such as a LAN or a WAN.

### (2. Actions of Image Forming System)

Next, the operation of the image forming system 1 according to the present embodiment will be described.

The second controller 21 of the image forming device 20 performs various adjustment operations at the start and end of a print job.

The adjustment operation is, for example, toner refresh adjustment, color registration adjustment, or the like. The toner refresh adjustment is adjustment for replacing deteriorated toner in the developing device. The color registration adjustment is adjustment for correcting color misregistration of YMCK.

The color, coverage, and the like of the job image of the print job vary depending on the print job. Therefore, the second controller 21 performs image formation control and conveyance control of the recording medium PM according to each print job between print jobs.

The image formation control is, for example, control for switching the photosensitive drum to be driven according to the color of a job image. For example, in color printing, the second controller 21 drives the photosensitive drums of YMCK. In monochrome printing, the second controller 21 drives the photosensitive drum of K only.

The conveyance control of the recording medium PM is, for example, control of the speed of image formation according to the coverage of a job image and the conveyance speed of the recording medium PM. For example, when the job image has a low coverage, the second controller 21 sets the speed of image formation and the conveyance speed of the recording medium PM to be higher than a predetermined value. When the job image has a high coverage, the second controller 21 sets the speed of image formation and the conveyance speed of the recording medium PM to be equal to or lower than a predetermined value.

In order to execute the various adjustment operations, the image formation control, and the conveyance control of the recording medium PM described above, the second controller 21 performs the following process. Specifically, the process is to stop conveyance of the recording medium PM between print jobs in a case where a plurality of print jobs is continuously printed on one recording medium PM.

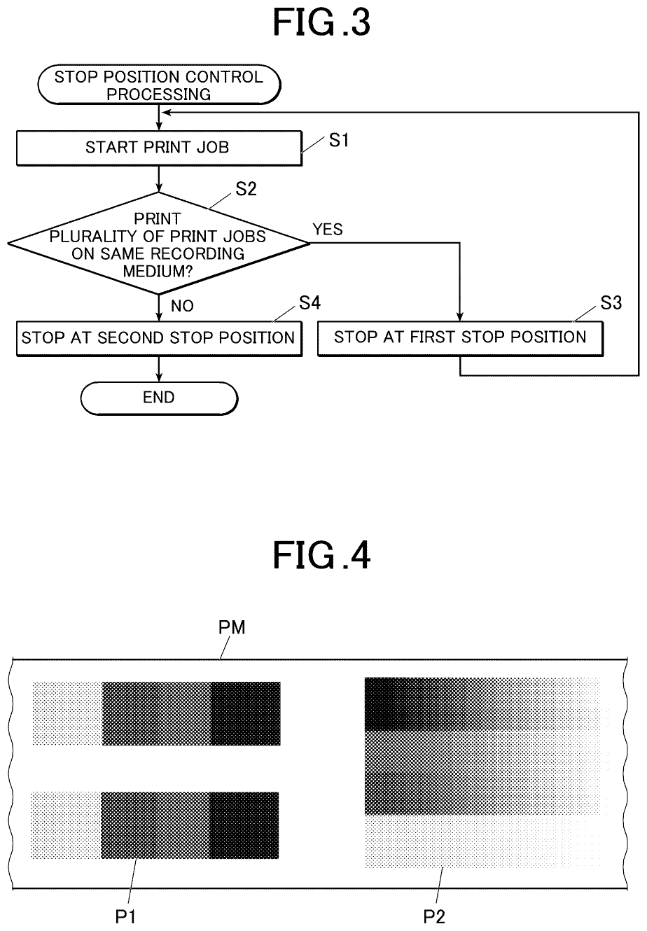

The second controller 21 controls the position at which the last image formed on the recording medium PM is stopped between print jobs by executing the stop position control processing illustrated in FIG. 3.

### (Stop Position Control Processing)

The second controller 21 starts a print job (Step S1).

In Step S1, the second controller 21 executes the print job acquired from an external device via the communication section 31.

Alternatively, in Step S1, the second controller 21 executes a print job input by the user via the operation receiver 22.

Alternatively, in Step S1, the second controller 21 executes a print job stored in advance in the storage section 29.

Next, the second controller 21 determines whether or not to print a plurality of print jobs on one recording medium PM held in the image forming system 1 (Step S2). The second controller 21 functions as a first determiner.

Before executing Step S2, the second controller 21 may obtain the following command from the user via the operation receiver 22 or the communication section 31. Specifically, the command is to set whether or not to print a plurality of print jobs on one recording medium PM held in the image forming system 1.

In this case, the second controller 21 sets whether or not to print a plurality of print jobs on one recording medium PM based on the command by the user. The second controller 21 functions as a first setter.

In this case, in Step S2, the second controller 21 determines whether or not to print a plurality of print jobs on one recording medium PM based on the setting by the first setter.

In Step S2, the second controller 21 may determine to print a plurality of print jobs on one recording medium PM held in the image forming system 1 in a case where a plurality of print jobs is reserved as print jobs to be executed by the image forming system 1.

That is, when a plurality of print jobs is reserved, the second controller 21 as the first determiner determines to print the plurality of print jobs on one continuous recording medium (recording medium PM) held in the image forming system 1.

In Step S2, the second controller 21 may determine to print a plurality of print jobs on one recording medium PM held in the image forming system 1 in a case where the print job that the second controller 21 started in Step S1 is a proof print job.

That is, when executing a proof print job, the second controller 21 as the first determiner determines to print a plurality of print jobs on one continuous recording medium (recording medium PM) held in the image forming system 1.

The proof print (test printing) is an image formation performed prior to actual image formation in order that the user can check the image formed on the recording medium PM.

In Step S2, the second controller 21 may determine to print a plurality of print jobs on one recording medium PM held in the image forming system 1 in a case where the print job that the second controller 21 started in Step S1 is an adjustment print job.

That is, when executing an adjustment print job, the second controller 21 as the first determiner determines to print a plurality of print jobs on one continuous recording medium (recording medium PM) held in the image forming system 1.

The adjustment print job is an image formation performed prior to actual image formation in order to correct the density, tone, and the like of the image formed on the recording medium PM. By executing the print adjustment job, the second controller 21 can suppress, for example, color fluctuation that occurs due to a difference in the material of the recording medium PM, a change in the surrounding environment of the image forming system 1, or the like. The second controller 21 executes a print adjustment job when the recording medium PM is changed or when the image forming system 1 is activated, for example.

The second controller 21 forms the correction patch on the recording medium PM in the adjustment print job. The correction patch is, for example, a density correction patch P1 and/or a tone correction patch P2 illustrated in FIG. 4.

Next, the second controller 21 acquires read image data that is a result of reading of the correction patch formed on the recording medium PM by the image reading device 40. Next, the second controller 21 performs density correction and/or tone correction based on the acquired read image data.

In Step S2, the second controller 21 may determine to print a plurality of print jobs on one recording medium PM held in the image forming system 1 in a case where the second controller 21 suspends the print job started in Step S1.

That is, when suspending the ongoing print job, the second controller 21 as the first determiner determines to print a plurality of print jobs on a single continuous recording medium (recording medium PM) held in the image forming system 1.

For example, when the second controller 21 detects deterioration of toner in the developing device during execution of the print job executed in Step S1, the second controller 21 suspends the print job. For example, the second controller 21 sets a predetermined threshold for the conveyance distance of the recording medium PM and/or the coverage of the image formed by the image forming section 25. When the conveyance distance of the recording medium PM and/or the coverage of the image formed by the image forming section 25 exceeds the threshold, the second controller 21 determines that the toner has deteriorated.

Next, the second controller 21 performs toner refresh adjustment. Next, the second controller 21 resumes the suspended print job.

In Step S2, the second controller 21 may determine to print a plurality of print jobs on one recording medium PM held in the image forming system 1 in the case where the second controller 21 stops the print job started in Step S1.

That is, the second controller 21 as the first determiner determines to print a plurality of print jobs on a single continuous recording medium (recording medium PM) held in the image forming system 1 when stopping the ongoing print job.

For example, when the user presses a printing stop button included in the operation receiver 22, the second controller 21 stops the print job started in Step S1.

Next, when a printing restart button of the operation receiver 22 is pressed by the user, the second controller 21 restarts the stopped print job.

A case where a plurality of print jobs is printed on one recording medium PM held in the image forming system 1 (Step S2; YES) will be described. In this case, the second controller 21 stops the last image formed on the recording medium PM of the print job started in Step S1 at the first stop position A1 shown in FIG. 1 (Step S3). The first stop position A1 is between the image reading section 42 and the winding section 52.

That is, the second controller 21 controls the conveyance by the conveyance sections 14, 27, 43, and 54 such that the stop position of the last image on the continuous recording medium (recording media PM) of the preceding print job is to be the first stop position A1 between the image reading section 42 and the winding section 52 in a case where a plurality of print jobs is printed on one continuous recording medium held in the image forming system 1. The second controller 21 functions as a controller.

Thus, generation of waste sheet can be suppressed between a plurality of print jobs for printing on one recording medium PM held in the image forming system 1.

Since the first stop position A1 is located on the downstream side of the image reading section 42 in the conveyance direction of the recording media PM, the image reading section 42 can read the last image on the recording medium PM.

As a result, the second controller 21 can perform density correction, tone correction, and the like based on the read image data which is the result of reading of the last image on the recording medium PM.

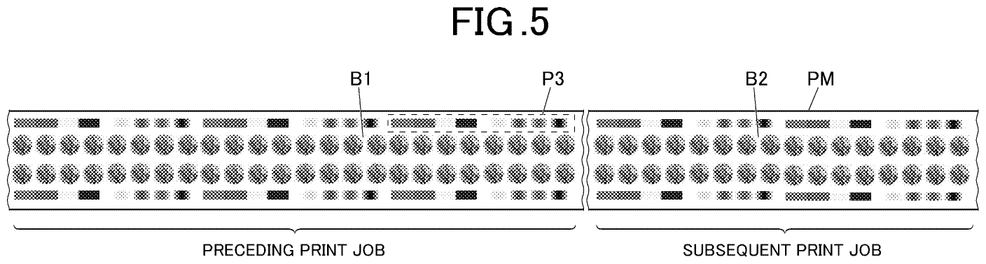

FIG. 5 illustrates an example of a job image B1 of a preceding print job, a job image B2 of a subsequent print job, and a correction patch P3 formed on the recording medium PM.

As shown in FIG. 5, the second controller 21 forms correction patches on both end sides in the main scanning direction of the job image in the preceding print job and the subsequent print job.

In the example illustrated in FIG. 5, the second controller 21 acquires read image data that is a result of reading of the last image by the image reading section 42 including the correction patch P3 on the recording medium PM. Next, the second controller 21 forms the job image B2 of the subsequent print job by performing density correction, tone correction, and the like based on the acquired read image.

The second controller 21 can perform image inspection of the last image based on read image data that is a result of reading of the last image. The second controller 21 compares the read image data read by the image reading section 42 with the original print image data to detect an abnormality such as stains or misregistration of the formed last image. The second controller 21 may use reference image data registered in advance instead of the original print image data.

A case where the print job started by the second controller 21 in Step S1 is a proof print job will be described. In this case, in Step S3, the second controller 21 stops the last image of the proof print job formed on the recording medium PM at the first stop position A1.

In the example illustrated in FIG. 1, the first stop position A1 is a position at which the user can visually check the image on the recording medium PM.

A case where the print job started by the second controller 21 in Step S1 is an adjustment print job will be described. In this case, in Step S3, the second controller 21 stops the last image of the adjustment print job formed on the recording medium PM at the first stop position A1.

A case where the second controller 21 suspends the print job started in Step S1 will be described. In this case, in Step S3, the second controller 21 stops the last image of the images formed on the recording medium PM before suspending the print job at the first stop position A1.

A case where the second controller 21 stops the print job started in Step S1 will be described. In this case, in Step S3, the second controller 21 stops the last image of the images formed on the recording medium PM before stopping the print job at the first stop position A1.

Next, the second controller 21 shifts the stop position control processing to Step S1.

The second controller 21 starts the subsequent print job in the second Step S1.

A case where the print job started by the second controller 21 in the first Step S1 is a proof print job or an adjustment print job will be described. In this case, the second controller 21 starts the actual print job in the second Step S1.

A case where the second controller 21 suspends the print job started in the first Step S1 will be described. In this case, in the second Step S1, the second controller 21 starts printing from the image next to the image formed on the recording medium PM before the print job is suspended.

A case where the second controller 21 stops the print job started in the first Step S1 will be described. In this case, in the second Step S1, the second controller 21 starts printing from the image next to the image formed on the recording media PM before the print job is stopped.

A case where printed on the recording medium PM held in the image forming system 1 is not a plurality of print jobs (Step S2; NO) will be described. That is, a case where only a single print job is printed on the recording medium PM held in the image forming system 1 will be described. In this case, the second controller 21 stops the last image formed on the recording medium PM of the print job started in Step S1 at the second stop position A2 shown in FIG. 1 (Step S4). The second stop position A2 is a position closer to the winding section 52 than the first stop position A1. For example, the second stop position A2 is a winding completion position where the recording medium PM is wound around the support shaft 521.

That is, the second controller 21 as the controller controls the conveyance by the conveyance sections 14, 27, 43, and 54 such that the stop position of the last image on the continuous recording medium (recording medium PM) of the preceding print job is the second stop position A2 closer to the winding section 52 than the first stop position A1 in a case where printed on one continuous recording medium held in the image forming system 1 is not a plurality of print jobs.

A case where the recording medium PM wound by the winding device 50 is carried out in a subsequent process such as processing and delivery after the end of the print job will be described. In this case, by stopping the last image on the recording medium PM at the second stop position A2, the recording medium PM can be easily carried out from the winding device 50.

Since the second stop position A2 is on the downstream side of the image reading section 42 in the conveyance direction of the recording medium PM, the last image on the recording medium PM can be read by the image reading section 42.

As a result, the second controller 21 can perform density correction, tone correction, and the like based on the read image data which is the reading result of the last image on the recording medium PM.

Next, the second controller 21 ends the stop position control processing.

### Modification Example

Next, the image forming system 1 of a modification example of the present embodiment described above will be described. The differences from the above-described embodiment will be mainly described below.

The image forming system 1 of the present modification example has the same configuration as the image forming system 1 of the above-described embodiment.

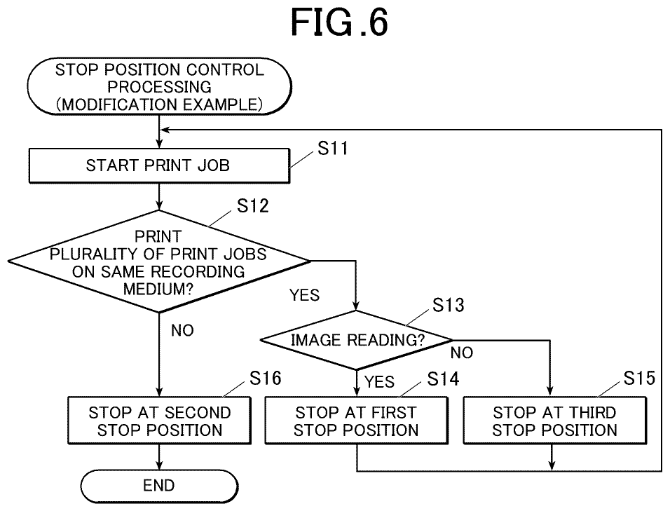

FIG. 6 illustrates a flowchart of stop position control processing of the present modification example.

In the present modification example, the second controller 21 acquires the following user's command via the operation receiver 22 or the communication section 31. Specifically, the command is to set whether to perform image correction during execution of a print job.

For example, when the print job is long-time or long-distance continuous printing, the user sets that image correction is performed.

For example, when a job image is to be printed on the entire surface of the recording medium PM in a print job, the user sets that image correction is not performed.

The second controller 21 sets whether to perform image correction during the execution of the print job based on the command by the user. The second controller 21 functions as a second setter.

In the present modification example, the second controller 21 acquires the following user's command via the operation receiver 22 or the communication section 31. Specifically, the command is to set whether to perform image inspection for inspecting an image formed on the recording medium PM.

Based on the command from the user, the second controller 21 sets whether to perform image inspection for inspecting the image formed on the recording medium PM. The second controller 21 functions as a third setter.

### (Stop Position Control Processing of Modification Example)

The second controller 21 performs Steps S11 and S12 similar to Steps S1 and S2 in the stop position control processing of the above-described embodiment.

A case of printing a plurality of print jobs on one recording medium PM held in the image forming system 1 (Step S12; YES) will be described. In this case, the second controller 21 determines whether or not the image formed on the recording medium PM is read by the image reading section 42 (Step S13). The second controller 21 functions as a second determiner.

A case where the second controller 21 as the second setter sets that image correction is performed during the execution of the print job will be described. In this case, in Step S13, the second controller 21 determines that the image formed on the recording medium PM is to be read by the image reading section 42.

That is, the second controller 21 serving as the second determiner determines to perform image reading when the second controller 21 as the second setter sets that image correction is performed during execution of a print job.

A case where the print job started by the second controller 21 in Step S1 is an adjustment print job will be described. In this case, in Step S13, the second controller 21 determines that the image formed on the recording medium PM is to be read by the image reading section 42.

That is, when executing an adjustment print job, the second controller 21 as the second determiner determines to perform image reading.

A case where the second controller 21 as the third setter sets that image inspection is performed will be described. In this case, in Step S13, the second controller 21 determines that the image formed on the recording medium PM is to be read by the image reading section 42.

That is, the second controller 21 as the second determiner determines to perform the reading of the image in a case where the second controller 21 as the third setter sets that the image inspection is performed.

A case where reading of the image formed on the recording medium PM by the image reading section 42 is performed (Step S13; YES) will be described. In this case, the second controller 21 stops the last image formed on the recording medium PM of the print job started in Step S1 at the first stop position A1 (Step S14).

That is, the second controller 21 as the controller controls the conveyance by the conveyance sections 14, 27, 43, and 54 so that the stop position of the last image on the continuous recording medium (recording medium PM) is to be the first stop position A1 between the image reading section 42 and the winding section 52 in a case where a plurality of print jobs is printed on one continuous recording medium held in the image forming system 1 and the image formed on the continuous recording medium is read by the image reading section 42.

A case where reading of the image formed on the recording medium PM by the image reading section 42 is not performed (Step S13; NO) will be described. In this case, the second controller 21 stops the last image formed on the recording medium PM of the print job started in Step S1 at the third stop position A3 shown in FIG. 1 (Step S15). The third stop position A3 is between the image forming section 25 and the image reading section 42.

That is, the second controller 21 as the controller controls the conveyance by the conveyance sections 14, 27, 43, and 54 such that the stop position of the last image on the continuous recording medium (recording medium PM) is to be the third stop position A3 between the image forming section 25 and the image reading section 42 in a case where a plurality of print jobs is printed on one continuous recording medium held in the image forming system 1 and the image formed on the continuous recording medium is not read by the image reading section 42.

As a result, generation of waste paper can be suppressed more than in a case where the last image is stopped at the first stop position A1 in a plurality of print jobs to be printed on one recording medium PM held in the image forming system 1.

After Step S14 or S15, the second controller 21 allows the stop position control processing to proceed to Step S11.

A case where printed on the recording medium PM held in the image forming system 1 is not a plurality of print jobs (Step S12; NO) will be described. That is, a case where only a single print job is printed on the recording medium PM held in the image forming system 1 will be described. In this case, the second controller 21 performs Step S16 which is the same as Step S4 of the stop position control processing of the above embodiment, and ends the stop position control processing.

In the stop position control processing of the above modification example, the second controller 21 may omit Steps S12 and S16.

### (3. Effects)

As described above, the image forming system 1 according to the present embodiment is an image forming system 1 that forms an image on a continuous recording medium (recording medium PM).

The image forming system 1 of the present embodiment includes the conveyance sections 14, 27, 43, and 54 that convey the continuous recording medium.

The image forming system 1 according to the present embodiment includes the image forming section 25 that forms an image on a continuous recording medium.

The image forming system 1 according to the present embodiment includes the image reading section 42 that reads an image formed on a continuous recording medium.

The image forming system 1 according to the present embodiment includes the winding section 52 that winds a continuous recording medium.

The image forming system 1 according to the present embodiment includes the controller (second controller 21 (hardware processor)).

The controller controls the conveyance by the conveyance section 14, 27, 43, and 54 such that the stop position of the last image on the continuous recording medium of the preceding print job is to be the first stop position A1 between the image reading section 42 and the winding section 52 in a case where a plurality of print jobs is printed on one continuous recording medium held in the image forming system 1.

The controller controls conveyance by the conveyance sections 14, 27, 43, and 54 such that the stop position of the last image on the continuous recording medium is to be the second stop position A2 closer to the winding section 52 than the first stop position A1 in a case where printed on one continuous recording medium is not a plurality of print jobs.

Thus, in a case of printing a plurality of print jobs on one recording medium PM held in the image forming system 1, generation of waste sheet can be more suppressed than in a case where the last image is stopped at the second stop position A2. Furthermore, density correction, tone correction, and the like can be performed based on the read image data that is the reading result of the last image on the recording medium PM.

When printed on one recording medium PM held in the image forming system 1 is not a plurality of print jobs, the recording medium PM can be easily ejected from the winding device 50.

Therefore, even when the image reading device is provided, waste sheet can be reduced.

The image forming system 1 of the present embodiment includes the first determiner (second controller 21 (hardware processor)) that determines whether or not to print a plurality of print jobs on one continuous recording medium (recording medium PM).

This makes it possible to automatically determine whether to print a plurality of print jobs on one recording medium PM held in the image forming system 1.

The image forming system 1 according to the present embodiment includes the first setter (second controller 21 (hardware processor)) that sets, based on a user command, whether or not to print a plurality of print jobs on a single continuous recording medium (recording medium PM).

Thus, the user can set whether to print a plurality of print jobs on one recording medium PM held in the image forming system 1.

In the image forming system 1 according to the present embodiment, the first determiner (second controller 21 (hardware processor)) determines to print a plurality of print jobs on a single continuous recording medium (recording medium PM) if a plurality of print jobs is reserved.

This makes it possible to easily determine whether to print a plurality of print jobs on one recording medium PM held in the image forming system 1.

In the image forming system 1 according to the present embodiment, the first determiner (second controller 21 (hardware processor)) determines to print a plurality of print jobs on a single continuous recording medium (recording medium PM) when a proof print job is to be executed.

This makes it possible to easily determine whether to print a plurality of print jobs on one recording medium PM held in the image forming system 1.

In the image forming system 1 according to the present embodiment, when an adjustment print job is to be executed, the first determiner (second controller 21 (hardware processor)) determines to print a plurality of jobs on a single continuous recording medium (recording medium PM).

This makes it possible to easily determine whether to print a plurality of print jobs on one recording medium PM held in the image forming system 1.

In the image forming system 1 of the present embodiment, the first determiner (second controller 21 (hardware processor)) determines to print a plurality of print jobs on one continuous recording medium (recording medium PM) in a case where the ongoing print job is suspended.

This makes it possible to easily determine whether to print a plurality of print jobs on one recording medium PM held in the image forming system 1.

In the image forming system 1 according to the present embodiment, the first determiner (second controller 21 (hardware processor)) determines to print a plurality of print jobs on a single continuous recording medium (recording medium PM) when stopping the ongoing print job.

This makes it possible to easily determine whether to print a plurality of print jobs on one recording medium PM held in the image forming system 1.

In the image forming system 1 of the present embodiment, the controller (second controller 21 (hardware processor)) controls conveyance by the conveyance sections 14, 27, 43, and 54 such that the stop position of the last image on the continuous recording medium (recording medium PM) of the preceding print job is to be the first stop position A1 in a case where a plurality of print jobs is printed on one continuous recording medium and the image formed on the continuous recording medium is read by the image reading section 42.

The controller controls conveyance by the conveyance sections 14, 27, 43, and 54 such that the stop position of the last image on the continuous recording medium is to be the third stop position A3 between the image forming section 25 and the image reading section 42 in a case where a plurality of print jobs is printed on one continuous recording medium and image reading is not performed.

Thus, in a case of printing a plurality of print jobs on one of the recording medium PM held in the image forming system 1, generation of waste sheet can be suppressed more than in a case where the last image is stopped at the second stop position A2. Furthermore, generation of waste sheet can be further suppressed compared to a case where the last image is stopped at the first stop position A1 when the image formed on the recording medium PM is not read by the image reading section 42. When the image reading section 42 reads the image on the recording medium PM, density correction, tone correction, and the like can be performed on the basis of the read image data, which is the result of reading the last image on the recording medium PM.

Therefore, even when the image reading device is provided, waste sheet can be reduced.

The image forming system 1 according to the present embodiment is the image forming system 1 that forms an image on a continuous recording medium (recording medium PM).

The image forming system 1 of the present embodiment includes the conveyance sections 14, 27, 43, and 54 that convey the continuous recording medium.

The image forming system 1 according to the present embodiment includes the image forming section 25 that forms an image on a continuous recording medium.

The image forming system 1 according to the present embodiment includes the image reading section 42 that reads an image formed on a continuous recording medium.

The image forming system 1 according to the present embodiment includes the winding section 52 that winds a continuous recording medium.

The image forming system 1 of the present embodiment includes the controller (second controller 21 (hardware processor)).

The controller controls conveyance by the conveyance sections 14, 27, 43, and 54 such that the stop position of the last image on the continuous recording medium is to be the first stop position A1 between the image reading section 42 and the winding section 52 in a case where the image formed on the continuous recording medium is read by the image reading section 42.

The controller controls conveyance by the conveyance sections 14, 27, 43, and 54 so that the stop position of the last image on the continuous recording medium is to be the third stop position A3 between the image forming section 25 and the image reading section 42 in a case where reading of the image formed on the continuous recording medium by the image reading section 42 is not performed.

Thus, in a case where the image on the recording medium PM is not read by the image reading section 42, generation of waste sheet can be further suppressed than in a case where the last image is stopped at the first stop position A1.

Therefore, even when the image reading device is provided, waste sheet can be reduced.

The image forming system 1 of the present embodiment includes a second determiner (second controller 21 (hardware processor)) that determines whether or not to cause the image reading section 42 to read an image formed on a continuous recording medium (recording medium PM).

This makes it possible to automatically determine whether the image reading section 42 is to read the image formed on the recording medium PM.

The image forming system 1 according to the present embodiment includes the second setter (second controller 21 (hardware processor)) that sets, based on a user's command, whether to perform image correction during execution of a print job.

The second determiner (second controller 21 (hardware processor)) determines to perform image reading when the second setter sets that image correction is to be performed.

This makes it possible to easily determine whether or not reading of the image formed on the recording medium PM is performed by the image reading section 42.

In the image forming system 1 of the present embodiment, the second determiner (the second controller 21 (hardware processor)) determines to perform image reading when an adjustment print job is executed.

This makes it possible to easily determine whether or not reading of the image formed on the recording medium PM is performed by the image reading section 42.

The image forming system 1 of the present embodiment includes the third setter (second controller 21 (hardware processor)) that sets whether or not to perform image inspection to inspect an image formed on a continuous recording medium (recording medium PM) on the basis of a user's command.

The second determiner (second controller 21 (hardware processor)) determines to perform image reading when the third setter sets to perform image inspection.

This makes it possible to easily determine whether or not reading of the image formed on the recording medium PM is performed by the image reading section 42.

Note that embodiments to which the present invention can be applied are not limited to those described above, and can be appropriately modified without departing from the spirit and scope of the present invention.

For example, in the above-described embodiment, the second controller 21 (hardware processor) functions as the controller, the first determiner, the second determiner, the first setter, the second setter, and the third setter, but the configuration is not limited thereto. The first controller 11, the third controller 41, or the fourth controller 51 may function as the controller, the first determiner, the second determiner, the first setter, the second setter, and the third setter (the hardware processor).

What is claimed is:

1. An image forming system that forms an image on a continuous recording medium, the image forming system comprising:
a conveyance section that conveys the continuous recording medium;
an image forming section that forms an image on the continuous recording medium;
an image reading section that reads the image on the continuous recording medium;
a winding section that winds up the continuous recording medium; and
a hardware processor that controls, when a plurality of print jobs is printed on one continuous recording medium held in the image forming system, conveyance by the conveyance section such that a stop position of a last image of a preceding print job on the continuous recording medium is to be a first stop position between the image reading section and the winding section,
and that controls, when printed on the one continuous recording medium is not a plurality of print jobs, the conveyance by the conveyance section such that the stop position of the last image on the continuous recording medium is to be a second stop position that is closer to the winding section than the first stop position.

2. The image forming system according to claim 1,
wherein the hardware processor determines whether a plurality of print jobs is printed on the one recording medium.

3. The image forming system according to claim 1,
wherein the hardware processor sets whether a plurality of print jobs is printed on the one recording medium according to a user's command.

4. The image forming system according to claim 2,
wherein, when a plurality of print jobs is reserved, the hardware processor determines that a plurality of print jobs is to be printed on the one recording medium.

5. The image forming system according to claim 2,
wherein, when a proof print job is to be executed, the hardware processor determines that a plurality of print jobs is to be printed on the one continuous recording medium.

6. The image forming system according to claim 2,
wherein, when an adjustment print job is to be executed, the hardware processor determines that a plurality of print jobs is to be printed on the one continuous recording medium.

7. The image forming system according to claim 2,
wherein, when the ongoing print job is suspended, the hardware processor determines that a plurality of print jobs is to be printed on the one continuous recording medium.

8. The image forming system according to claim 2,
wherein, when the ongoing print job is stopped, the hardware processor determines that a plurality of print jobs is to be printed on the one continuous recording medium.

9. The image forming system according to claim 1,
wherein, when a plurality of print jobs is printed on the one continuous recording medium and image reading of the image formed on the continuous recording medium is performed by the image reading section, the hardware processor controls the conveyance by the conveyance section such that the stop position of the last image of the preceding print job on the continuous recording medium is the first stop position,
wherein, when a plurality of print jobs is printed on the one continuous recording medium and the image reading is not performed, the hardware processor controls the conveyance by the conveyance section such that the stop position of the last image on the continuous recording medium is a third stop position between the image forming section and the image reading section.

10. An image forming system that forms an image on a continuous recording medium, the image forming system comprising:
a conveyance section that conveys the continuous recording medium;
an image forming section that forms an image on the continuous recording medium;
an image reading section that reads an image on the continuous recording medium;
a winding section that winds up the continuous recording medium; and
a hardware processor that controls, when image reading of an image formed on the continuous recording medium is performed by the image reading section, conveyance by the conveyance section such that a stop position of a last image on the continuous recording medium is a first stop position between the image reading section and the winding section
and that controls, when the image reading of the image formed on the continuous recording medium is not performed by the image reading section, the conveyance by the conveyance section such that the stop position of the last image on the continuous recording medium is a third stop position between the image forming section and the image reading section.

11. The image forming system according to claim 10,
wherein the hardware processor determines whether the image reading is performed on the continuous recording medium.

12. The image forming system according to claim 11,
wherein the hardware processor sets whether or not image correction is performed during execution of a print job based on a user's command,
wherein the hardware processor determines that the image reading is to be performed by the image reading section when the hardware processor sets that the image correction is to be performed.

13. The image forming system according to claim 11,
wherein the hardware processor determines that the image reading is to be performed by the image reading section when an adjustment print job is to be performed.

14. The image forming system according to claim 11,
wherein the hardware processor sets whether or not an image inspection to inspect the image formed on the continuous recording medium is performed based on a user's command,
wherein the hardware processor determines that the image reading is performed when the hardware processor sets that the image inspection is to be performed.

15. A non-transitory computer-readable storage medium storing a program for a computer of an image forming system,
wherein the image forming system comprises:
a conveyance section that conveys the continuous recording medium;
an image forming section that forms an image on the continuous recording medium;
an image reading section that reads the image on the continuous recording medium; and
a winding section that winds up the continuous recording medium,
wherein the program causes the computer of the image forming system to:
control, when a plurality of print jobs is printed on one continuous recording medium held in the image forming system, conveyance by the conveyance section such that a stop position of a last image of a preceding print job on the continuous recording medium is to be a first stop position between the image reading section and the winding section; and
control, when printed on the one continuous recording medium is not a plurality of print jobs, the conveyance by the conveyance section such that the stop position of the last image on the continuous recording medium is to be a second stop position that is closer to the winding section than the first stop position.
